(19) United States
(12) Patent Application Publication
(10) Pub. No.: US 2026/0213670 A1
(43) Pub. Date: Jul. 23, 2026

(54) MULTI-OUTPUT FLYBACK CONVERTER, CONTROL METHOD THEREFOR, AND SWITCHED-MODE POWER SUPPLY

(71) Applicant: Zhuhai Nanxin Semiconductor Technology Co., Ltd., Zhuhai City (CN)

(72) Inventors: Xi TANG, Zhuhai City (CN); Nan WANG, Zhuhai City (CN); Lin FENG, Zhuhai City (CN)

(21) Appl. No.: 19/455,860

(22) Filed: Jan. 22, 2026

(30) Foreign Application Priority Data
Jan. 22, 2025 (CN) 202510102593.0

(51) Int. Cl. H02M 3/335

(52) U.S. Cl. CPC H02M 3/33576

(57) ABSTRACT

The present disclosure, relating to the technical field of power electronics, provides a multi-output flyback converter, a control method therefor, a switched-mode power supply, and a chip. The multi-output flyback converter according to the present disclosure includes a multi-output flyback converter circuit, N load branches, and a controller. During a process in which the multi-output flyback converter circuit provides energy to the N load branches, the controller detects the load condition of the N load branches in real time. In a case where it is detected that a load branch enters a light-load state, the controller controls the load branch to be electrically disconnected from the multi-output flyback converter circuit to stop transferring energy to the load branch. Therefore, the switching loss of the light-load branch is reduced and the overall energy conversion efficiency of the multi-output flyback converter is improved.

### CROSS REFERENCE TO THE RELATED APPLICATIONS

This application is based upon and claims priority to Chinese Patent Application No. 202510102593.0, filed on Jan. 22, 2025, the entire contents of which are incorporated herein by reference.

### TECHNICAL FIELD

The present disclosure relates to the technical field of power electronics, and in particular, relates to a multi-output flyback converter, a control method therefor, a switched-mode power supply, and a chip.

### BACKGROUND

With the rapid development of application of power electronics technologies, stringent requirements are being imposed on smaller size, higher efficiency, and greater reliability of switching converters. A flyback converter is a type of power electronics converter that controls the storage and release of energy in a transformer via a switching transistor. Due to characteristics, such as a simple topology and few components, it is widely used in switched-mode power supplies.

For a flyback converter, it is necessary to achieve high power supply efficiency across the entire load range to meet the power supply demands of different types of loads. In the related art, a flyback converter includes a primary circuit, a secondary circuit, and a control circuit. Under no-load or light-load conditions, the output power of the flyback converter decreases. Therefore, it is necessary to reduce the proportion of energy loss to improve the energy conversion efficiency of the flyback converter.

In the related art, the control circuit controls the switching frequency of a high-frequency power switching transistor on the primary circuit by detecting the total load condition of the flyback converter. This reduces the switching frequency of the flyback converter, thereby improving its energy conversion efficiency under no-load or light-load conditions. However, the method in the related art, which improves energy conversion efficiency by detecting the total load condition to control the switching frequency of the high-frequency power switching transistor on the primary side, is not suitable for multi-output flyback converters.

### SUMMARY

Embodiments of the present disclosure provide a multi-output flyback converter, a control method therefor, a switched-mode power supply, and a chip, to improve the energy conversion efficiency of the multi-output flyback converter under no-load or light-load conditions.

In a first aspect, the embodiments of the present disclosure provide a multi-output flyback converter. The multi-output flyback converter includes: a multi-output flyback converter circuit, N load branches, and a controller, N being a positive integer greater than 1; wherein the multi-output flyback converter circuit includes a voltage input circuit, a first power switching transistor, and a first transformer including a primary winding and a secondary winding; and each of the N load branches includes a voltage output circuit and a load.

The voltage input circuit is electrically connected to a first terminal of the primary winding, a second terminal of the primary winding is grounded via the first power switching transistor, a first terminal of the secondary winding is electrically connected to respective voltage input terminals of the voltage output circuits on the N load branches, and a second terminal of the secondary winding is indirectly grounded; N first input terminals of the controller are electrically connected in a one-to-one correspondence to N voltage output terminals of the N voltage output circuits, N first output terminals of the controller are electrically connected to control signal input terminals of the N voltage output circuits, and a second output terminal of the controller is electrically connected to a control terminal of the first power switching transistor.

The controller is configured to: sample, in real time, output voltages supplied by the voltage output circuits on the N load branches to the loads, to obtain N sampled voltages; and control a first load branch among the N load branches to be electrically disconnected from the secondary winding to stop transferring energy to the first load branch, in a case where it is determined, based on the N sampled voltages, that the first load branch is in a light-load state.

During a time period where the energy transfer to the first load branch stops, in a case where a second load branch among the N load branches is in a non-light-load state and a total load condition of the N load branches has not reached a system light-load threshold, the controller is further configured to control the second load branch to be electrically connected to the secondary winding, such that all energy output by the multi-output flyback converter is transferred to the second load branch.

In some embodiments, the controller is further configured to control the voltage output circuit on the first load branch and the secondary winding to be in electrical conduction to enable the secondary winding to transfer energy to the first load branch, in a case where it is determined, based on the output voltage supplied by the voltage output circuit on the first load branch to the load, that the first load branch exits the light-load state.

In some embodiments, in a case where there are a plurality of the second load branches, the plurality of the second load branches are in a complementary conduction state.

In some embodiments, the multi-output flyback converter further includes N load control circuits, wherein an n^{th} load control circuit corresponds to an n^{th} load branch, n=1, 2, . . . , N.

The n^{th} load control circuit includes an n^{th} voltage sampling circuit, an n^{th} operational amplifier, and an n^{th} burst mode detection circuit which are electrically connected in sequence, the n^{th} voltage sampling circuit being electrically connected to a voltage output terminal of an n^{th} voltage output circuit on the n^{th} load branch, and a first output terminal of the n^{th} burst mode detection circuit being electrically connected to a control signal input terminal on the n^{th} voltage output circuit.

The n^{th} voltage sampling circuit is configured to sample an output voltage supplied by the n^{th} voltage output circuit to an n^{th} load to obtain an n^{th} sampled voltage, and input the n^{th} sampled voltage to the n^{th} operational amplifier.

The n^{th} operational amplifier is configured to receive a reference voltage corresponding to the n^{th} load branch and the n^{th} sampled voltage, and perform an operation on the reference voltage corresponding to the n^{th} load branch and the n^{th} sampled voltage to output an n^{th} operation result, wherein the n^{th} operation result is used to indicate a load condition of the n^{th} load branch.

the n^{th} burst mode detection circuit is configured to: determine, based on the n^{th} operation result transmitted from the n^{th} operational amplifier, whether the n^{th} load branch is in the light-load state or a non-light-load state; and in a case where it is determined that the n^{th} load branch is in the light-load state, transmit an n^{th} control signal to the control signal input terminal of the n^{th} voltage output circuit, such that the n^{th} voltage output circuit is electrically disconnected from the secondary winding based on the n^{th} control signal; or in a case where it is determined that the n^{th} load branch is in the non-light-load state, transmit the n^{th} control signal to the control signal input terminal of the n^{th} voltage output circuit, such that electrical conduction is achieved between the n^{th} voltage output circuit and the secondary winding based on the n^{th} control signal.

In some embodiments, the n^{th} burst mode detection circuit is specifically configured to: determine that the n^{th} load branch is in the light-load state in a case where the n^{th} operation result is less than a predetermined voltage threshold corresponding to the n^{th} load branch; and determine that the n^{th} load branch is in the non-light-load state in a case where the n^{th} operation result is greater than or equal to the predetermined voltage threshold.

In some embodiments, the n^{th} voltage output circuit includes an n^{th} switching circuit and an n^{th} output capacitor, the first output terminal of the n^{th} burst mode detection circuit being electrically connected to a control signal input terminal of the n^{th} switching circuit.

The n^{th} burst mode detection circuit is specifically configured to control the n^{th} switching circuit to turn on or turn off, to achieve electrical conduction or disconnection between the n^{th} load branch and the secondary winding.

In some embodiments, the n^{th} switching circuit includes a first unidirectional switch and a second unidirectional switch that are connected in series; and the n^{th} burst mode detection circuit is specifically configured to transmit a same n^{th} control signal to the first unidirectional switch and the second unidirectional switch such that the n^{th} load branch is electrically disconnected from the secondary winding in a case where the n^{th} load branch is in the light-load state, and transmit the same n^{th} control signal to the first unidirectional switch and the second unidirectional switch such that electrical conduction is achieved between the n^{th} load branch and the secondary winding in a case where the n^{th} load branch exits the light-load state.

Alternatively, the n^{th} switching circuit is a back-to-back metal-oxide-semiconductor field-effect transistor (MOSFET) module; and the n^{th} burst mode detection circuit is specifically configured to transmit different n^{th} control signals to two MOSFETs of the back-to-back MOSFET module respectively to control one MOSFET of the back-to-back MOSFET module to be constantly on and control the other MOSFET of the back-to-back MOSFET module to turn off in a case where the n^{th} load branch is in the light-load state, such that the n^{th} load branch is electrically disconnected from the secondary winding, and control the other MOSFET of the back-to-back MOSFET module to turn on in a case where the n^{th} load branch exits the light-load state, such that electrical conduction is achieved between the n^{th} load branch and the secondary winding.

Alternatively, the n^{th} switching circuit is a bidirectional switch; and the n^{th} burst mode detection circuit is specifically configured to transmit the n^{th} control signal to the bidirectional switch based on whether the corresponding n^{th} load branch is in the light-load state, such that the bidirectional switch is turned on or turned off along a first direction, wherein the first direction is a direction from the secondary winding to the n^{th} load branch.

In some embodiments, the controller further includes an isolation communication circuit and a primary control circuit, wherein the isolation communication circuit is disposed between the N load control circuits and the primary control circuit, and an output terminal of the primary control circuit is electrically connected to the control terminal of the first power switching transistor.

The operational amplifiers on the N load control circuits are configured to respectively transmit the generated operation results to the primary control circuit via the isolation communication circuit.

The primary control circuit is configured to control, based on the received N operation results, the first power switching transistor to turn on or turn off.

In a second aspect, the embodiments of the present disclosure provide a control method for a multi-output flyback converter. The method is applied in the controller in the multi-output flyback converter according to the first aspect. The method includes:
sampling, in real time, output voltages supplied by voltage output circuits on N load branches of the multi-output flyback converter to loads, wherein N is a positive integer greater than 1;
controlling a first load branch among the N load branches to be electrically disconnected from a secondary winding of a transformer in the multi-output flyback converter to stop transferring energy to the first load branch, in a case where it is determined that the first load branch is in a light-load state; and
during a time period where the energy transfer to the first load branch is stopped, in a case where a second load branch among the N load branches is in a non-light-load state and a total load condition of the N load branches has not reached a system light-load threshold, controlling the second load branch to be electrically connected to the secondary winding, such that all energy output by a multi-output converter circuit in the multi-output flyback converter is transferred to the second load branch.

In a third aspect, the embodiments of the present disclosure provide a switched-mode power supply. The switched-mode power supply includes the multi-output flyback converter according to the first aspect.

In a fourth aspect, the embodiments of the present disclosure provide a chip. The chip includes the multi-output flyback converter according to the first aspect.

The present disclosure provides a multi-output flyback converter, a control method therefor, a switched-mode power supply, and a chip. The multi-output flyback converter includes a multi-output flyback converter circuit, N load branches, and a controller. During a process in which the multi-output flyback converter circuit provides energy to the N load branches, the controller detects the load condition of the N load branches in real time. In a case where it is detected that a load branch enters a light-load state, the controller controls the load branch to be electrically disconnected from the multi-output flyback converter circuit to stop transferring energy to the load branch. In this way, the multi-output flyback converter circuit transfers all energy to the load branch or branches that are in a non-light-load state. This reduces the number of switching operations for the light-load branch, thereby reducing the switching loss of the light-load branch and improving the overall energy conversion efficiency of the multi-output flyback converter. Furthermore, disconnecting the light-load branch also prevents the problem of excessive energy.

### BRIEF DESCRIPTION OF THE DRAWINGS

FIG. 1 is a schematic structural diagram of a flyback converter in the related art.

FIG. 2 is a structural diagram illustrating an application scenario of a multi-output flyback converter according to an embodiment of the present disclosure.

FIG. 3 is a structural diagram of a multi-output flyback converter according to another embodiment of the present disclosure.

FIG. 4 is a structural diagram of a dual-output flyback converter according to an embodiment of the present disclosure.

FIG. 5 is a timing diagram of the dual-output flyback converter illustrated in FIG. 4.

FIG. 6 is a structural diagram of a dual-output flyback converter according to another embodiment of the present disclosure.

FIG. 7 is a timing diagram of the dual-output flyback converter illustrated in FIG. 6.

FIG. 8 is a structural diagram of a dual-output flyback converter according to another embodiment of the present disclosure.

FIG. 9 is a flowchart of a control method for a multi-output flyback converter according to an embodiment of the present disclosure.

### DETAILED DESCRIPTION OF THE EMBODIMENTS

In the present disclosure, the term “at least one” refers to one or more than one, and the term “a plurality of” refers to two or more than two. The term “and/or” is merely an association relationship for describing associated objects, which represents that there may exist three types of relationships. For example, the phrase “A and/or B” means (A), (B), or (A and B), wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

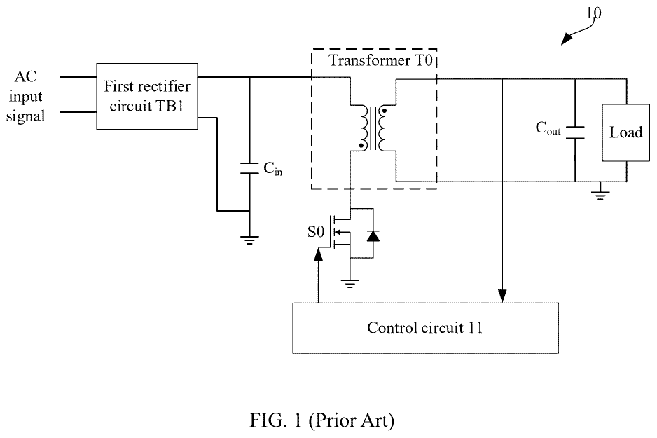

FIG. 1 is a schematic structural diagram of a flyback converter 10 in the related art. Referring to FIG. 1, the flyback converter 10 includes a first rectifier circuit TB1, a primary-side input capacitor Cᵢₙ, a transformer T0, a primary power switching transistor S0, a secondary-side output capacitor Cₒᵤₜ, and a control circuit 11.

In the flyback converter 10 illustrated in FIG. 1, the primary power switching transistor S0 is, for example, an n-channel metal-oxide-semiconductor field-effect transistor (NMOSFET).

The first rectifier circuit TB1, the primary-side input capacitor Cᵢₙ, a primary winding of the transformer T0, and the primary power switching transistor S0 form a primary circuit of the flyback converter 10. An input terminal of the first rectifier circuit TB1 is configured to receive an AC signal, a first output terminal of the first rectifier circuit TB1 is electrically connected to a first terminal of the primary-side input capacitor Cᵢₙ, and a second output terminal of the first rectifier circuit TB1 is electrically connected to a second terminal of the primary-side input capacitor Cᵢₙ and is grounded. The first terminal of the primary-side input capacitor Cᵢₙ is electrically connected to a first terminal of the primary winding of the transformer T0, a second terminal of the primary winding of the transformer T0 is electrically connected to a drain of the primary power switching transistor S0, and a source of the primary power switching transistor S0 is grounded.

A secondary winding of the transformer T0, the secondary-side output capacitor Cₒᵤₜ, and a load form a secondary circuit of the flyback converter 10. A first terminal of the secondary winding of the transformer T0 is electrically connected to a first terminal of the secondary-side output capacitor Cₒᵤₜ through a blocking diode VD0, a second terminal of the secondary winding of the transformer T0 is electrically connected to a second terminal of the secondary-side output capacitor Cₒᵤₜ and is grounded, and the load is connected in parallel across both terminals of the secondary-side output capacitor Cₒᵤₜ.

An input terminal of the control circuit 11 is electrically connected to the first terminal of the secondary-side output capacitor Cₒᵤₜ. Thus, the control circuit 11 acknowledges the total load condition by detecting the voltage at the first terminal of the secondary-side output capacitor Cₒᵤₜ. Further, an output terminal of the control circuit 11 is electrically connected to a gate of the primary power switching transistor S0.

In the present disclosure, a load condition refers to the condition of the power required by a load. The load condition may be classified into a light-load state and a non-light-load state.

The non-light-load state refers to a situation where the power required by the load is greater than a predetermined power threshold. The non-light-load state includes a heavy-load state, a full-load state, and the like. The heavy-load state refers to a situation where the power required by the load approaches a designed maximum power value. The full-load state refers to a situation where the power required by the load reaches the designed maximum power value.

The light-load state refers to a situation where the power required by the load is less than the predetermined power threshold. In the present disclosure, the light-load state indicates that the power required by the load is relatively small or that no power is required. The situation where no power is required by the load may also be referred to as a no-load state.

For example, the predetermined power threshold may be 30% of the maximum power.

Hereinafter, for simplicity of description, a load branch in the light-load state is referred to as a light-load branch, and a load branch in the non-light-load state is referred to as a non-light-load branch.

During operation of the flyback converter illustrated in FIG. 1, in a case where the control circuit 11 determines that the current total load condition is a non-light-load state by detecting the voltage at the first terminal of the secondary-side output capacitor Cₒᵤₜ, the control circuit 11 inputs a drive signal to the gate of the primary power switching transistor S0. This causes the primary power switching transistor S0 to switch periodically, thereby controlling the primary circuit of the flyback converter 10 to periodically transfer energy to the secondary circuit.

In a case where the control circuit 11 determines that the current total load condition is a light-load state by detecting the voltage at the first terminal of the secondary-side output capacitor Cₒᵤₜ, the flyback converter 10 enters a burst mode and intermittently transmits pulses to the load. The flyback converter 10 entering the burst mode may also be understood as controlling the primary power switching transistor S0 to enter the burst mode. Specifically, the control circuit 11 inputs a drive signal to the gate of the primary power switching transistor S0 to change the duration of the switching period of the primary power switching transistor S0, thereby reducing the switching frequency of the flyback converter 10. In this way, the energy supplied by the flyback converter 10 to the load is reduced to match the total load condition, such that the energy conversion efficiency of the flyback converter 10 is improved.

However, the method in the related art, which improves the energy conversion efficiency of the flyback converter by having the control circuit detect the total load condition to control the switching frequency of the primary power switching transistor S0 on a primary side, is not suitable for a multi-output flyback converter.

Specifically, for a multi-output flyback converter, taking a converter with two load branches as an example, in a case where one load branch is a light-load branch and the other is a non-light-load branch, the total load condition may not reach a system light-load threshold (a predetermined total power threshold). In this case, the multi-output flyback converter may not enter the burst mode to change the switching frequency of the high-frequency power switching transistor on the primary side. As a result, the energy loss caused by frequent switching operations of the light-load branch is high, which is detrimental to the improvement of the overall energy conversion efficiency. Furthermore, in a case where the multi-output flyback converter does not enter the burst mode, the energy transferred to the light-load branch may be greater than the energy required by the light-load branch, such that overvoltage protection is triggered for the light-load branch. This is not conducive to the stable and reliable operation of the light-load branch.

In view of this, the present disclosure provides a multi-output flyback converter, a control method therefor, a switched-mode power supply, and a chip. The multi-output flyback converter according to the present disclosure includes a multi-output flyback converter circuit, N load branches, and a controller. During a process in which the multi-output flyback converter circuit supplies energy to the N load branches, the controller detects the load condition of the N load branches in real time. In a case where it is detected that a load branch enters a light-load state, the controller controls the load branch to enter the burst mode, such that the light-load branch is electrically disconnected from the multi-output flyback converter circuit, i.e., stopping the transfer of energy to the load branch. In this way, because the total load condition has not reached the system light-load threshold, the multi-output flyback converter circuit transfers all energy to the load branches that are in a non-light-load state, and the first power switching transistor on the primary side of the flyback converter circuit does not need to enter the burst mode. Disconnecting the light-load branch reduces the number of switching operations for the light-load branch on the secondary side, such that the switching loss caused by the light-load branch is reduced, which is conducive to improving the energy conversion efficiency of the multi-output flyback converter. Furthermore, the load branch in the light-load state does not absorb energy until the load branch exits the light-load state, which solves the problem of excessive energy in the light-load branch and is conducive to the stable and reliable operation of the light-load branch.

Next, the multi-output flyback converter according to the present disclosure is described in detail with reference to some specific embodiments.

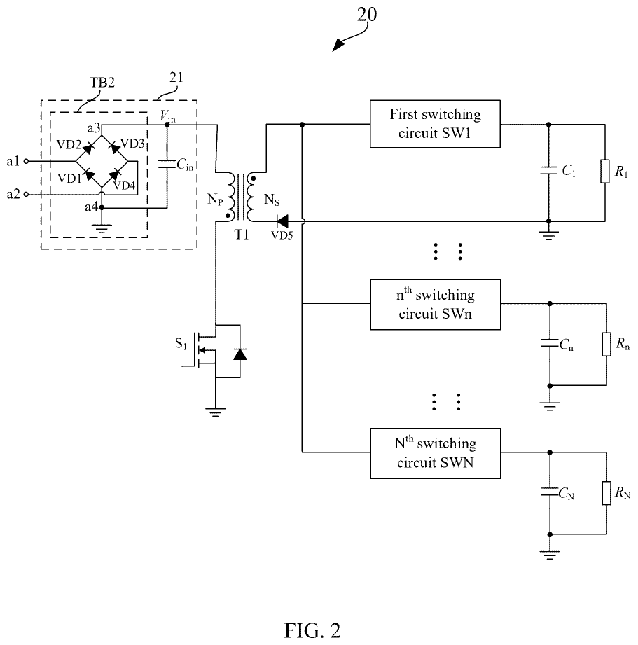

The present disclosure is mainly applied to multi-output flyback converter circuits. FIG. 2 is a schematic diagram illustrating an application architecture of a multi-output flyback converter circuit 20 according to an embodiment of the present disclosure. Referring to FIG. 2, the multi-output flyback converter circuit 20 includes a voltage input circuit 21 and a first power switching transistor S1 that are disposed on the primary side, and a first transformer T1 including a primary winding Np and a secondary winding Ns. The secondary winding Ns of the first transformer T1 is electrically connected to first terminals of N load branches and is configured to supply energy to the N load branches. N is a positive integer greater than 1.

The voltage input circuit 21, the first power switching transistor S1, and the primary winding of the first transformer form a primary circuit of the multi-output flyback converter circuit 20.

In some embodiments, the voltage input circuit 21 includes a second rectifier circuit TB2 and a first input capacitor Cᵢₙ.

The second rectifier circuit TB2 may be a bridge circuit formed by four bridge-connected diodes. As illustrated in FIG. 2, the second rectifier circuit TB2 includes a first diode VD1, a second diode VD2, a third diode VD3, and a fourth diode VD4. A cathode of the first diode VD1 is electrically connected to an anode of the second diode VD2, a cathode of the second diode VD2 is electrically connected to a cathode of the third diode VD3, an anode of the third diode VD3 is electrically connected to a cathode of the fourth diode VD4, and an anode of the fourth diode VD4 is electrically connected to an anode of the first diode VD1.

A first connection node a1 located between the first diode VD1 and the second diode VD2, and a second connection node a2 located between the third diode VD3 and the fourth diode VD4, serve as two input terminals of the second rectifier circuit TB2. A third connection node a3 located between the second diode VD2 and the third diode VD3, and a fourth connection node a4 located between the first diode VD1 and the fourth diode VD4, serve as two output terminals of the second rectifier circuit TB2.

The third connection node a3 is electrically connected to a first terminal of the first input capacitor Cin, and the fourth connection node a4 is electrically connected to a second terminal of the first input capacitor Cin and is grounded.

The third connection node a3, serving as an output terminal of the voltage input circuit 21, is electrically connected to a first terminal of the primary winding Np of the first transformer T1; a second terminal of the primary winding Np of the first transformer T1 is electrically connected to a first terminal of the first power switching transistor S1; and a second terminal of the first power switching transistor S1 is grounded. A control terminal of the first power switching transistor S1 is configured to receive a corresponding drive signal.

The first power switching transistor S1 may be an NMOSFET or a PMOSFET. In a case where the first power switching transistor S1 is an NMOSFET, the first terminal is a drain of the NMOSFET, the second terminal is a source of the NMOSFET, and the control terminal is a gate of the NMOSFET. In a case where the first power switching transistor S1 is a p-channel MOSFET (PMOSFET), the first terminal is a source of the PMOSFET, the second terminal is a drain of the PMOSFET, and the control terminal is a gate of the PMOSFET.

The secondary winding Ns of the first transformer T1 and the N load branches form a secondary circuit of the multi-output flyback converter circuit 20. A first terminal of the secondary winding Ns of the first transformer T1, serving as an output terminal of the multi-output flyback converter circuit 20, is electrically connected to a first terminal of each of the N load branches; and a second terminal of the secondary winding Ns of the first transformer T1 is indirectly connected to a second terminal of each of the N load branches and is grounded.

In some embodiments, a diode is disposed between the second terminal of the secondary winding Ns of the first transformer T1 and the N load branches. The unidirectional conduction characteristic of the diode helps to block reverse energy transfer from the secondary winding Ns to the primary winding Np. Specifically, the second terminal of the secondary winding Ns of the first transformer T1 is electrically connected to a cathode of a fifth diode VD5, and an anode of the fifth diode VD5 is electrically connected to the second terminal of each of the N load branches and is grounded.

An n^{th} load branch includes an n^{th} voltage output circuit and an n^{th} load Rn. The n^{th} voltage output circuit includes an n^{th} switching circuit SWn and an n^{th} output capacitor Cn. A first terminal of the n^{th} switching circuit SWn is electrically connected to the first terminal of the secondary winding Ns, a second terminal of the n^{th} switching circuit SWn is electrically connected to a first terminal of the n^{th} output capacitor Cn, a second terminal of the n^{th} output capacitor Cn is grounded, and the n^{th} load Rn is electrically connected in parallel across both terminals of the n^{th} output capacitor Cn. n=0, 1, 2, . . . , N. The n^{th} switching circuit SWn is configured to control the n^{th} load branch and the secondary winding Ns of the first transformer T1 to be in electrical conduction or disconnection. The n^{th} output capacitor Cn is configured to store the energy transferred from the secondary winding Ns and release energy to the n^{th} load Rn.

The switching circuit on any load branch may be implemented in any of the following ways. Taking the n^{th} voltage output circuit as an example: In some embodiments, the n^{th} switching circuit SWn is a first unidirectional switch Qn1 and a second unidirectional switch Qn2 that are connected in series.

In some other embodiments, the n^{th} switching circuit SWn is a back-to-back MOSFET module, which includes two back-to-back series-connected MOSFETs.

In still other embodiments, the n^{th} switching circuit SWn is a bidirectional switch.

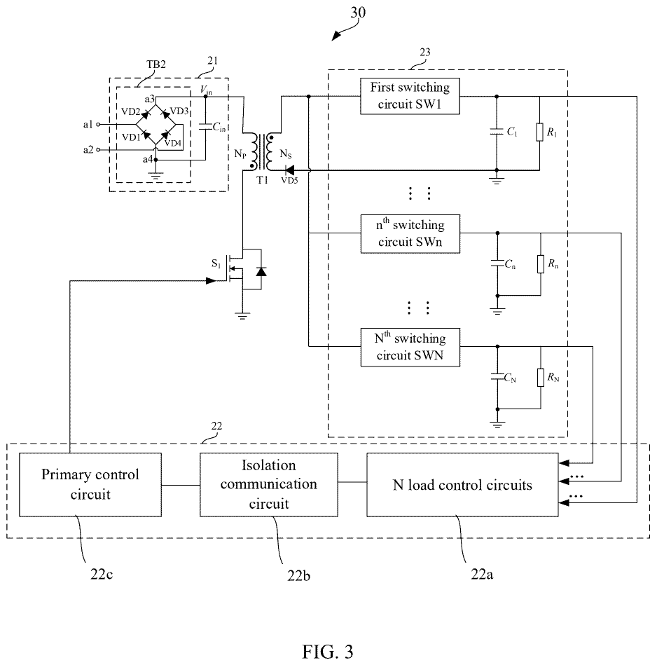

FIG. 3 is a structural diagram of a multi-output flyback converter 30 according to an embodiment of the present disclosure. Referring to FIG. 3, the multi-output flyback converter 30 includes the multi-output flyback converter circuit 20 illustrated in FIG. 2, a controller 22, and N load branches 23.

Input terminals of the controller 22 are respectively electrically connected to output terminals of the voltage output circuits on the N load branches. The controller 22 samples the output voltages respectively supplied by the N voltage output circuits to obtain N sampled voltages. N first output terminals of the controller 22 are electrically connected, in one-to-one correspondence, to control signal input terminals of N switching circuits. The controller 22 transmits control signals to the control signal input terminals of the N switching circuits respectively. A second output terminal of the controller 22 is electrically connected to a control terminal of the first power switching transistor S1. In FIG. 3, taking the first power switching transistor S1 being an NMOSFET as an example, the second output terminal of the controller 22 is electrically connected to a gate of the first power switching transistor S1.

In some embodiments, the controller 22 includes N load control circuits 22a, an isolation communication circuit 22b, and a primary control circuit 22c.

The number of load control circuits is equal to the number of load branches, and the N load control circuits are Electrically connected, in one-to-one correspondence, to the N load branches. Specifically, a first input terminal of an n^{th} load control circuit is electrically connected to a first terminal of an n^{th} output capacitor Cn on an n^{th} load branch, and a first output terminal of the n^{th} load control circuit is electrically connected to a control signal input terminal of an n^{th} switching circuit SWn on the n^{th} load branch.

Second output terminals of the N load control circuits are both electrically connected to a first terminal of the isolation communication circuit 22b. A second terminal of the isolation communication circuit 22b is electrically connected to an input terminal of the primary control circuit 22c; and an output terminal of the primary control circuit 22c, serving as the second output terminal of the controller 22, is electrically connected to the control terminal of the first power switching transistor S1.

Each load control circuit is configured to sample the output voltage provided by the connected load branch to its load, and calculate the load condition of that load branch based on the sampled voltage and a reference voltage, and then perform energy transfer control based on the load condition.

In the present disclosure, the energy transfer control performed by the load control circuit may be understood as burst mode control. Burst mode control for a load branch refers to an operating mode of intermittently transmitting pulses to the load branch based on the load condition on the load branch. In the present disclosure, in a case where a load branch enters a light-load state, the load branch enters a burst mode, and the first transformer T1 stops transferring energy to the load branch; or in a case where the load branch exits the light-load state, the load branch exits the burst mode, and the first transformer T1 resumes supplying energy to the load branch.

Furthermore, the N load control circuits transmit their respectively calculated load conditions of the load branches to the primary control circuit 22c via the isolation communication circuit 22b. The primary control circuit 22c may thus obtain the load conditions of all load branches and control, based on the total load condition, whether the first power switching transistor S1 enters the burst mode, i.e., control the switching frequency of the first power switching transistor S1 to adjust the output power of the multi-output flyback converter circuit, such that the output power of the multi-output flyback converter circuit matches the total load condition.

Based on the embodiment illustrated in FIG. 3, optionally, the n^{th} load control circuit includes an n^{th} voltage sampling circuit, an n^{th} operational amplifier, and an n^{th} burst mode detection circuit. An input terminal of the n^{th} voltage sampling circuit is electrically connected to a voltage output terminal of the n^{th} voltage output circuit on the n^{th} load branch, i.e., the input terminal of the n^{th} voltage sampling circuit is electrically connected to the first terminal of the n^{th} output capacitor Cn. An output terminal of the n^{th} voltage sampling circuit is electrically connected to a first input terminal of the n^{th} operational amplifier, and a second input terminal of the n^{th} operational amplifier is configured to receive a reference voltage Vrefn corresponding to the n^{th} load branch. An output terminal of the n^{th} operational amplifier is electrically connected to an input terminal of the n^{th} burst mode detection circuit, and an output terminal of the n^{th} burst mode detection circuit is electrically connected to the control signal input terminal of the n^{th} voltage output circuit, i.e., the output terminal of the n^{th} burst mode detection circuit is electrically connected to a control terminal of the n^{th} switching circuit SWn. The output terminal of the n^{th} operational amplifier is further electrically connected to an input terminal of the isolation communication circuit 22b.

In the present disclosure, during operation of the multi-output flyback converter 30, in a case where the total power of the N load branches has not reached a system light-load threshold and there are a plurality of load branches in a non-light-load state, the plurality of non-light-load branches are in a complementary conduction state to prevent energy transfer among the plurality of non-light-load branches.

For example, in a case where all N load branches are in the non-light-load state, the N load branches being in the complementary conduction state means that at any given moment, electrical conduction is achieved between only one load branch and the secondary winding Ns of the first transformer T1, while the other N-1 load branches are all electrically disconnected from the secondary winding Ns of the first transformer T1.

It should be noted that the output voltages supplied by the N load branches to their respective loads may be the same or different.

Taking N=3 as an example, in a case where the output voltages supplied by the three load branches to their respective loads are completely different, the three load branches being in the complementary conduction state means: in a case where load branch 1 is turned on, load branch 2 and load branch 3 are turned off; when load branch 2 is turned on, load branch 1 and load branch 3 are turned off; and in a case where load branch 3 is turned on, load branch 1 and load branch 2 are both turned off.

Taking N=3 as an example, in a case where the output voltages supplied by the three load branches to their respective loads are partially the same, specifically, the output voltages of load branch 1 and load branch 2 are the same, and the output voltage of load branch 3 is different from those of load branch 1 and load branch 2, the three load branches being in the complementary conduction state means: in a case where load branch 1 is turned on, load branch 2 and load branch 3are turned off; in a case where load branch 2 is turned on, load branch 1 and load branch 3 are turned off; and in a case where load branch 3 is turned on, load branch 1 and load branch 2 are both turned off.

The complementary conduction of the N load branches may be achieved by the N load control circuits transmitting control signals for turning on the switching circuits to the switching circuits on the N load branches at different times within one cycle.

Taking the case where the output voltages of the N load branches are completely different as an example, the operating process of the multi-output flyback converter 30 illustrated in FIG. 3 is as follows.

The voltage input circuit in the primary circuit receives an AC input signal, converts the AC input signal into a DC input signal using the second rectifier circuit, and then delivers the DC input signal to the primary winding Np of the first transformer T1 via the input capacitor Cin. In a case where the primary control circuit 22c controls the first power switching transistor S1 to turn on, the primary winding Np of the first transformer T1 transfers energy to the secondary winding Ns, and the secondary winding Ns transfers the energy to the load branch among the N load branches that is in a conduction state.

During the above process, the n^{th} voltage sampling circuit on the n^{th} load control circuit may sample, in real time, the voltage Von at the first terminal of the n^{th} output capacitor Cn to generate an n^{th} sampled voltage Vosn, and transmit the n^{th} sampled voltage Vosn to the n^{th} operational amplifier. The n^{th} operational amplifier performs an operation on the n^{th} sampled voltage Vosn and the reference voltage Vrefn corresponding to the n^{th} load branch to obtain an n^{th} operation result Vcompn. The n^{th} operation result Vcompn reflects the current load condition of the n^{th} load branch. The n^{th} operational amplifier transmits the n^{th} operation result Vcompn to the n^{th} burst mode detection circuit. The n^{th} burst mode detection circuit then compares the n^{th} operation result Vcompn with a predetermined voltage threshold Vcompn-th corresponding to the n^{th} load branch. In a case where the n^{th} operation result Vcompn is less than the predetermined voltage threshold Vcompn-th, it is determined that the n^{th} load branch has entered the light-load state, and the n^{th} load branch needs to enter the burst mode. The n^{th} burst mode detection circuit transmits an n^{th} control signal to the n^{th} switching circuit SWn on the n^{th} load branch to cause the n^{th} switching circuit SWn to turn off, such that the n^{th} load branch is electrically disconnected from the secondary winding Ns of the first transformer T1. In a case where the n^{th} operation result Vcompn is greater than or equal to the predetermined voltage threshold Vcompn-th, it is determined that the n^{th} load branch has exited the light-load state, and the n^{th} load branch needs to exit the burst mode. The n^{th} burst mode detection circuit transmits an n^{th} control signal to the n^{th} switching circuit SWn on the n^{th} load branch to cause the n^{th} switching circuit SWn to turn on, such that electrical conduction is achieved between the n^{th} load branch and the secondary winding Ns of the first transformer T1, thereby enabling the secondary winding Ns to transfer energy to the n^{th} load.

In the present disclosure, the transfer of energy from the secondary winding Ns of the first transformer T1 to a load branch may also be understood as the secondary winding Ns of the first transformer T1 transmitting pulses to the load branch; and the meanings are the same.

Based on the determination of the n^{th} burst mode detection circuit, in a case where the n^{th} load branch enters the burst mode, after the n^{th} load branch stops transmitting pulses, the n^{th} output capacitor Cn on the n^{th} load branch may continue to discharge to maintain the output voltage level. Upon elapse of a period of time, the output voltage Von on the n^{th} load branch may decrease. In a case where the output voltage Von on the n^{th} load branch decreases, the n^{th} operation result Vcompn output by the n^{th} operational amplifier to becomes greater than or equal to the predetermined voltage threshold Vcompn-th, and thus the n^{th} load branch may be turned on again and exit the burst mode. The secondary winding Ns of the first transformer T1 resumes transmitting pulses to the n^{th} load branch, i.e., the multi-output flyback converter circuit replenishes energy to the n^{th} output capacitor Cn, causing the output voltage Von at the first terminal of the n^{th} output capacitor Cn to rise again.

In a case where the output voltage Von supplied by the n^{th} load branch to the n^{th} load Rn rises, and the n^{th} burst mode detection circuit determines that the n^{th} load branch needs to re-enter the burst mode, an n^{th} control signal is transmitted again to the n^{th} switching circuit SWn on the n^{th} load branch, such that the n^{th} load branch is electrically disconnected from the secondary winding Ns of the first transformer T1. This process repeats in a continuous cycle.

The multi-output flyback converter illustrated in FIG. 3 is capable of controlling the energy transfer from the first transformer to the loads based on the actual power demand of the loads. By disconnecting the light-load branch, the number of switching operations for the light-load branch is reduced, thereby reducing the switching loss of the light-load branch and improving the energy conversion efficiency of the multi-output flyback converter. Meanwhile, stopping pulse transmission to the light-load branch when the load branch is in the light-load state also prevents the problem of excessive energy in the light-load branch.

Based on the embodiment illustrated in FIG. 3, the n^{th} operational amplifier may, but is not limited to, obtain the n^{th} operation result in the following way: The n^{th} operational amplifier calculates a voltage difference between the n^{th} sampled voltage Vosn and the reference voltage Vrefn, then calculates a product of the voltage difference and a coefficient kn corresponding to the n^{th} load branch, and uses the calculated product as the n^{th} operation result Vcompn.

The present disclosure does not limit the specific implementation of the operational amplifier; and described above is merely an example.

Next, examples are provided for a multi-output flyback converter connected to two load branches, with different implementations of the switching components on the load branches. The two load branches are a first load branch and a second load branch, respectively. Correspondingly, the load control circuits include a first load control circuit and a second load control circuit, wherein the first load control circuit corresponds to the first load branch, and the second load control circuit corresponds to the second load branch.

### Case 1: The Switching Assembly Includes Two Series-Connected Unidirectional Switches

A unidirectional switch may be a transistor, such as an NMOSFET or a PMOSFET, or alternatively, a gallium nitride (GaN) device.

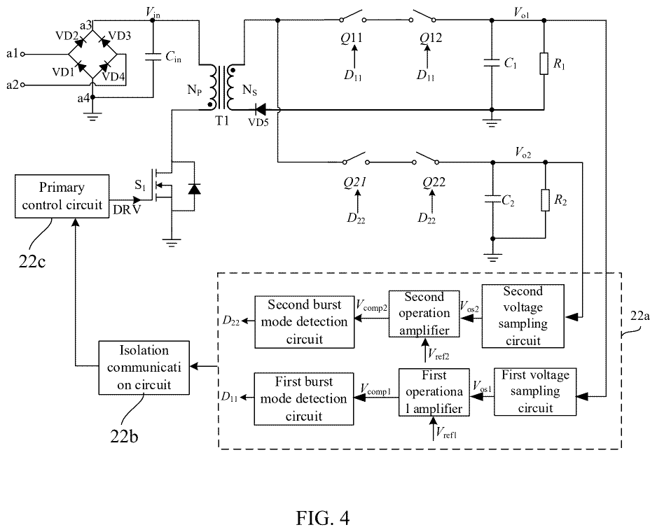

Referring to FIG. 4, the primary circuit of the dual-output flyback converter is identical in structure to the primary circuit illustrated in FIG. 2. For details, reference may be made to the detailed description of FIG. 2, which are not described herein any further for the sake of brevity. Furthermore, on the secondary circuit, a second terminal of the secondary winding Ns of the first transformer T1 is electrically connected to a cathode of a fifth diode VD5, and an anode of the fifth diode VD5 is connected to the second ends of both of the two load branches and is grounded.

On the secondary circuit, a first load branch includes a first switching circuit SW1 including a first unidirectional switch Q11 and a second unidirectional switch Q12, a first output capacitor C1, and a first load R1. A first terminal of the first unidirectional switch Q11 is electrically connected to a first terminal of the secondary winding Ns of the first transformer T1, a second terminal of the first unidirectional switch Q11 is electrically connected to a first terminal of the second unidirectional switch Q12, a second terminal of the second unidirectional switch Q12 is electrically connected to a first terminal of the first output capacitor C1, and a second terminal of the first output capacitor C1 is grounded. A first terminal of the first load R1 is electrically connected to the first terminal of the first output capacitor C1, and a second terminal of the first load R1 is grounded. Control signal input terminals of the first unidirectional switch Q11 and the second unidirectional switch Q12 are respectively electrically connected to a first output terminal of a first burst mode detection circuit on a first load control circuit. The first burst mode detection circuit transmits a same control signal D11 to control the first unidirectional switch Q11 and the second unidirectional switch Q12.

A second load branch includes a second switching circuit SW2 including a first unidirectional switch Q21 and a second unidirectional switch Q22, a second output capacitor C2, and a second load R2. A first terminal of the first unidirectional switch Q21 is electrically connected to the first terminal of the secondary winding Ns of the first transformer T1, a second terminal of the first unidirectional switch Q21 is electrically connected to a first terminal of the second unidirectional switch Q22, a second terminal of the second unidirectional switch Q22 is electrically connected to a first terminal of the second output capacitor C2, and a second terminal of the second output capacitor C2 is grounded. A first terminal of the second load R2 is electrically connected to the first terminal of the second output capacitor C2, and a second terminal of the second load R2 is grounded. Control signal input terminals of the first unidirectional switch Q21 and the second unidirectional switch Q22 are respectively electrically connected to an output terminal of a second burst mode detection circuit on a second load control circuit. The second burst mode detection circuit transmits a same control signal D22 to control the first unidirectional switch Q21 and the second unidirectional switch Q22.

The operating process of the dual-output flyback converter illustrated in FIG. 4 is as follows.

The first load control circuit determines the load condition of the first load branch. In a case where it is determined that the first load branch has entered a light-load state, the first load control circuit transmits a same first control signal D11 to the first unidirectional switch Q11 and the second unidirectional switch Q12 to turn off the switching circuit SW1 formed by the first unidirectional switch Q11 and the second unidirectional switch Q12. In a case where the first load branch exits the light-load state, the first load control circuit transmits the same first control signal D11 to the first unidirectional switch Q11 and the second unidirectional switch Q12 to turn on the switching circuit SW1 again.

The second load control circuit determines the load condition of the second load branch. In a case where it is determined that the second load branch has entered a light-load state, the second load control circuit transmits a same second control signal D22 to the first unidirectional switch Q21 and the second unidirectional switch Q22 to turn off the switching circuit SW2 formed by the first unidirectional switch Q21 and the second unidirectional switch Q22. In a case where the second load branch exits the light-load state, the second load control circuit transmits the same second control signal D22 to the first unidirectional switch Q21 and the second unidirectional switch Q22 to turn on the switching circuit SW2 again.

It should be noted that in the embodiment illustrated in FIG. 4, in a case where neither the first load branch nor the second load branch is a light-load branch, the first load branch and the second load branch are in the complementary conduction state.

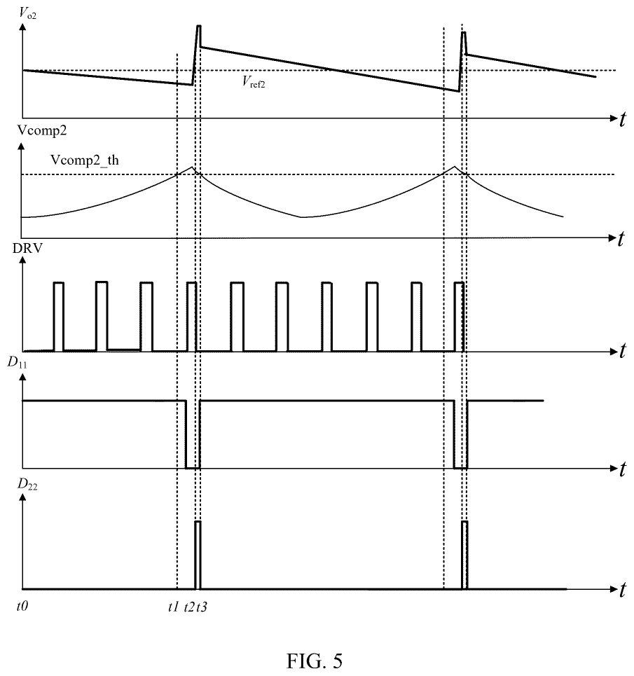

Next, taking the case where the first load branch is in a non-light-load state, the second load branch enters a light-load state, and the total load condition has not reached the system light-load threshold as an example, the operating process of the dual-output flyback converter is described in detail with reference to the signal timing diagram illustrated in FIG. 5.

The signal timing diagram illustrated in FIG. 5 specifically illustrates the temporal variations of the output voltage Vo2 supplied by the second load branch, the second operation result Vcomp2 output by a second operational amplifier, a drive signal DRV for the first power switching transistor S1, the first control signal D11 output by the first burst mode detection circuit to the first load branch, and the second control signal D22 output by the second burst mode detection circuit to the second load branch.

For the output voltage Vo2 supplied by the second load branch, the horizontal axis of the coordinate system represents time t, and the vertical axis represents the output voltage Vo2. The dashed line in the coordinate system represents a reference voltage Vref2 received by the second operational amplifier. The reference voltage Vref2 is the reference voltage corresponding to the second load branch.

For the second operation result Vcomp2, the horizontal axis of the coordinate system represents time t, and the vertical axis represents the second operation result Vcomp2. The dashed line in the coordinate system is a predetermined voltage threshold Vcomp-th2 used by the second burst mode detection circuit for burst mode determination. The magnitude of the predetermined voltage threshold Vcomp-th2 is related to the load magnitude on the second load branch.

For the drive signal DRV, the horizontal axis of the coordinate system represents time t, and the vertical axis represents the level of the drive signal DRV.

For the first control signal D11, the horizontal axis of the coordinate system represents time t, and the vertical axis represents the level of the first control signal D11.

For the second control signal D22, the horizontal axis of the coordinate system represents time t, and the vertical axis represents the level of the second control signal D22.

Reference may be made to FIG. 4 and FIG. 5 together.

At time t0, the output voltage Vo2 is less than or equal to the reference voltage Vref2. The second burst mode detection circuit determines that the second operation result Vcomp2 output by the second operational amplifier is less than the predetermined voltage threshold Vcomp-th2, determining that the second load branch has entered the light-load state and needs to enter the burst mode. Consequently, the second burst mode detection circuit transmits a low-level second control signal D22 to the two unidirectional switches of the second switching circuit SW2, to control the second switching circuit SW2 to turn off. The secondary winding Ns of the first transformer T1 stops transferring energy to the second load branch. The secondary winding Ns of the first transformer T1 supplies all energy thereof to the first load branch.

Since the second output capacitor C2 has stored a specific amount of energy, the second output capacitor C2 may continue to supply power to the second load R2. The output voltage Vo2 supplied by the second output capacitor C2 may gradually decrease over time, the difference between the second output voltage Vo2 and the reference voltage Vref2 may continuously increase, and correspondingly, the second operation result Vcomp2 may increase.

At time t1, the second operation result Vcomp2 is equal to the predetermined voltage threshold Vcomp-th2. The second burst mode detection circuit determines that the second load branch has exited the light-load state, i.e., the second load branch needs to exit the burst mode. Since the first load branch and the second load branch are in the complementary conduction state, the second switching circuit SW2 on the second load branch may only switch to the on state in a case where the dual-output flyback converter completes the on-time of the current cycle. Referring to the timing of the drive signal DRV and the first control signal D11 in FIG. 5, the second load branch needs to remain off during the time period from t1 to t2, i.e., the second control signal D22 is a low-level signal during the time period from t1 to t2. Based on this, the output voltage Vo2 may further decrease during the time period from t1 to t2.

At time t2, the on-time of the current cycle for the dual-output flyback converter is completed. The second burst mode detection circuit transmits a high-level second control signal D22 to the switching component SW2 on the second load branch to electrically connect the second load branch to the secondary winding Ns of the first transformer T1. The second output capacitor C2 on the second load branch is charged, the output voltage Vo2 supplied by the second output capacitor C2 increases, the difference between the output voltage Vo2 and the reference voltage Vref2 gradually decreases, and correspondingly, the operation result Vcomp2 gradually decreases.

Throughout the entire operating process of the dual-output flyback converter, the second burst mode detection circuit monitors the load condition of the second load branch in real time.

At time t3, the second burst mode detection circuit again detects that the second operation result Vcomp2 is less than the predetermined voltage threshold Vcomp-th2. The second load branch re-enters the light-load state and enters the burst mode. The second burst mode detection circuit transmits a low-level second control signal D22 to the second switching circuit SW2 to control the second switching circuit SW2 to turn off. Upon time t3, the output voltage Vo2 may continuously decrease until the second load branch exits the light-load state, exits the burst mode, and is turned on again.

In this way, the process is repeated continuously, thereby achieving control of the output voltage Vo2 on the second load branch.

During the above process, the first load branch is a non-light-load branch, and the first burst mode detection circuit transmits the first control signal to the switching circuit SW1 according to a pre-designed switching cycle. Referring to the timing of the first control signal D11 and the drive signal DRV, it is apparent that the first control signal D11 and the drive signal DRV are in the complementary conduction state during the time period from t1 to t2.

In a case where the total load condition has not reached the system light-load threshold, when it is detected that the first load branch is a light-load branch and the second load branch is a non-light-load branch, the control method for the first load branch is similar to that for the second load branch. For details, reference may be made to the detailed description above, which are not described herein any further for the sake of brevity.

Furthermore, in a case where both the first load branch and the second load branch are in the light-load state, the primary control circuit 22c is capable of determining that the total load condition has reached the system light-load threshold based on the first operation result Vcomp1 transmitted from the first load control circuit and the second operation result Vcomp2 transmitted from the second load control circuit, and then controlling the first power switching transistor S1 to enter the burst mode (i.e., enter an intermittent pulse transmission state).

### Case 2: The Switching Assembly is a Back-to-Back MOSFET Module

A back-to-back MOSFET module is a switching circuit formed by two MOSFETs of the same type connected back-to-back in series.

For example, a back-to-back MOSFET module includes a first NMOS transistor and a second NMOSFET. A drain of the first NMOSFET is electrically connected to a drain of the second NMOSFET; a source of the first NMOSFET, serving as a first terminal of the back-to-back MOSFET module, is electrically connected to the first terminal of the secondary winding Ns of the first transformer T1; a source of the second NMOSFET, serving as a second terminal of the back-to-back MOSFET module, is electrically connected to a first terminal of an output capacitor; and a gate of the first NMOSFET and a gate of the second NMOSFET, serving as two control signal input terminals of the back-to-back MOSFET module, are electrically connected to two first output terminals of a burst mode detection circuit on a load control circuit.

During operation of this exemplary back-to-back MOSFET module, the burst mode detection circuit transmits different control signals to the two MOSFETs, respectively. One NMOSFET is turned on or turned off based on the received control signal, while the other NMOSFET remains constantly on based on another received control signal. For example, the first NMOSFET is turned on or turned off based on a received control signal, while the second NMOSFET remains constantly on based on another received control signal. As another example, the second NMOSFET is turned on or turned off based on a received control signal, while the first NMOSFET remains constantly on based on another received control signal.

For example, a back-to-back MOSFET module includes a first PMOSFET and a second PMOSFET. A source of the first PMOSFET is electrically connected to a source of the second PMOSFET. A drain of the first PMOSFET, serving as a first terminal of the back-to-back MOSFET module, is electrically connected to the first terminal of the secondary winding Ns of the first transformer T1; a drain of the second PMOSFET, serving as a second terminal of the back-to-back MOSFET module, is electrically connected to a first terminal of an output capacitor; and a gate of the first PMOSFET and a gate of the second PMOSFET, serving as control signal input terminals of the back-to-back MOSFET module, are electrically connected to an output terminal of a burst mode detection circuit on a load control circuit.

During operation of this exemplary back-to-back MOSFET module, the burst mode detection circuit transmits different control signals to the two MOSFETs, respectively. One MOSFET is turned on or turned off based on a received control signal, while the other MOSFET remains constantly on based on another received control signal. For example, the first PMOSFET is turned on or turned off based on a received control signal, while the second PMOSFET remains constantly on based on another received control signal. As another example, the second PMOSFET is turned on or turned off based on a received control signal, while the first PMOSFET remains constantly on based on another received control signal.

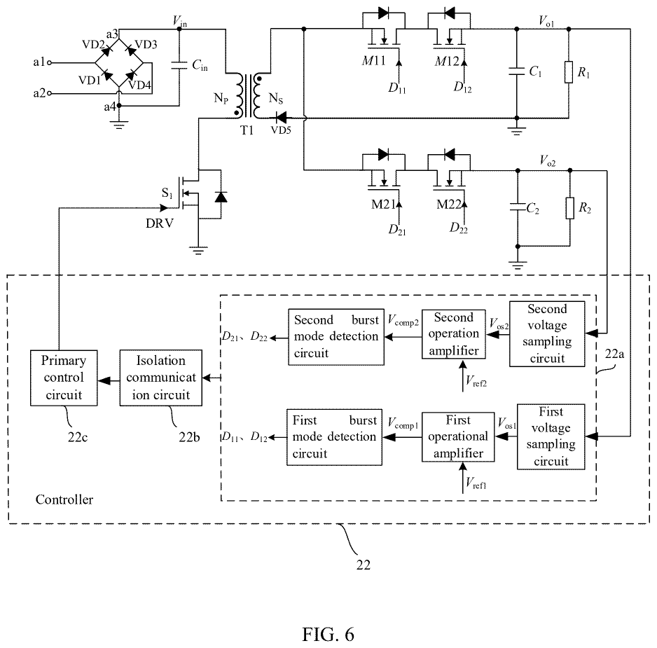

Referring to FIG. 6, the primary circuit of the dual-output flyback converter is identical in structure to the primary circuit illustrated in FIG. 2. For details, reference may be made to the detailed description of FIG. 2, which are not described herein any further for the sake of brevity. Furthermore, on the secondary circuit, a second terminal of the secondary winding Ns of the first transformer T1 is electrically connected to a cathode of a fifth diode VD5, and an anode of the fifth diode VD5 is connected to the second ends of both of the two load branches and is grounded.

This example uses a back-to-back MOSFET module, formed by a first NMOS transistor and a second NMOSFET connected back-to-back in series, as the switching circuit.

On the secondary circuit, a first load branch includes a first switching circuit SW1 including a first NMOSFET M11 and a second NMOSFET M12, a first output capacitor C1, and a first load R1. A drain of the first NMOSFET M11 is electrically connected to a drain of the second NMOSFET M12; a source of the first NMOSFET M11, serving as a first terminal of the first switching circuit SW1, is electrically connected to a first terminal of the secondary winding Ns of the first transformer T1; a source of the second NMOSFET M12, serving as a second terminal of the first switching circuit SW1, is electrically connected to a first terminal of the first output capacitor C1; and a gate of the first NMOSFET M11 and a gate of the second NMOSFET M12, serving as two control signal input terminals of the first switching circuit SW1, are respectively electrically connected in a one-to-one correspondence to two first output terminals of a first burst mode detection circuit on a first load control circuit. A first terminal of the first load R1 is electrically connected to the first terminal of the first output capacitor C1, and a second terminal of the first load R1 is electrically connected to a second terminal of the first output capacitor C1 and is grounded.

In the embodiment illustrated in FIG. 6, a first control signal includes a control signal D11 and a control signal D12. The first burst mode detection circuit transmits the control signal D11 to the first NMOSFET M11 on the first load branch, and transmits the first control signal D12 to the second NMOSFET M12 on the first load branch.

A second load branch includes a second switching circuit SW2 including a first NMOSFET M21 and a second NMOSFET M22, a second output capacitor C2, and a second load R2. A drain of the first NMOSFET M21 is electrically connected to a drain of the second NMOSFET M22; a source of the first NMOSFET M21, serving as a first terminal of the second switching circuit SW2, is electrically connected to the first terminal of the secondary winding Ns of the first transformer T1; a source of the second NMOSFET M22, serving as a second terminal of the second switching circuit SW2, is electrically connected to a first terminal of the second output capacitor C2; and a gate of the first NMOSFET M21 and a gate of the second NMOSFET M22, serving as two control signal input terminals of the second switching circuit SW2, are respectively electrically connected in a one-to-one correspondence to two first output terminals of a second burst mode detection circuit on a second load control circuit. A first terminal of the second load R2 is electrically connected to the first terminal of the second output capacitor C2, and a second terminal of the second load R2 is electrically connected to a second terminal of the second output capacitor C2 and is grounded.

In the embodiment illustrated in FIG. 6, a second control signal includes a control signal D21 and a control signal D22. The second burst mode detection circuit transmits the control signal D21 to the first NMOSFET M21 on the second load branch, and transmits the control signal D22 to the second NMOSFET M22 on the second load branch.

The operating process of the dual-output flyback converter illustrated in FIG. 6 is as follows.

The first load control circuit determines the load condition of the first load branch. In a case where it is determined that the first load branch has entered a light-load state, the first load control circuit controls the first NMOSFET M11 on the first load branch to turn off. In a case where the first load branch exits the light-load state, the first load control circuit controls the first NMOSFET M11 on the first load branch to turn on again. During this process, the second NMOSFET M12 on the first load branch remains in a constantly-on state. The second load control circuit determines the load condition of the second load branch.

In a case where it is determined that the second load branch has entered a light-load state, the second load controls the second NMOSFET M22 on the second load branch to turn off. In a case where the second load branch exits the light-load state, the second load controls the second NMOSFET M22 on the second load branch to turn on again. During this process, the first NMOSFET M21 on the second load branch remains in a constantly-on state.

It should be noted that in the embodiment illustrated in FIG. 6, in a case where both the first load branch and the second load branch are in a non-light-load state, the first load branch and the second load branch need to be in the complementary conduction state. During the operating process of the dual-output flyback converter illustrated in FIG. 6, since the control signals D12 and D21 are always at a high level, the turning on and turning off of the two load branches are mainly determined by the control signals D11 and D22. When both the first load branch and the second load branch are in a non-light-load state, the control signals D11 and D22 need to be complementary to ensure that the first load branch and the second load branch are in the complementary conduction state.

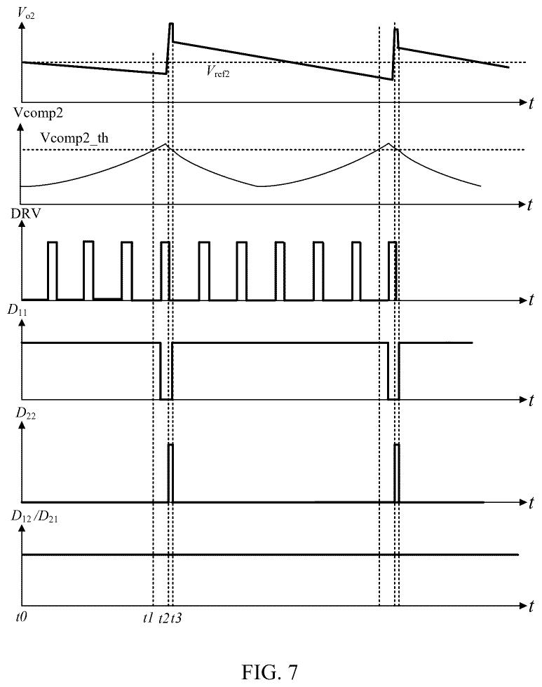

Next, taking the case where the first load branch is in a non-light-load state, the second load branch enters a light-load state, and the total load condition has not reached the system light-load threshold as an example, the operating process of the dual-output flyback converter illustrated in FIG. 6 is described in detail with reference to the signal timing diagram illustrated in FIG. 7.

The signal timing diagram illustrated in FIG. 7 specifically illustrates the temporal variations of the output voltage Vo2 supplied by the second load branch, the second operation result Vcomp2 output by a second operational amplifier, the drive signal DRV for the first power switching transistor S1, the control signals D11 and D12 output by the first burst mode detection circuit, and the control signals D21 and D22 output by the second burst mode detection circuit.

For the output voltage Vo2 supplied by the second load branch, the horizontal axis of the coordinate system represents time t, and the vertical axis represents the output voltage Vo2. The dashed line in the coordinate system is a reference voltage Vref2 received by the second operational amplifier on the second load control circuit. The reference voltage Vref2 is the reference voltage corresponding to the second load branch.

For the operation result Vcomp2, the horizontal axis of the coordinate system represents time t, and the vertical axis represents the operation result Vcomp2. The dashed line in the coordinate system is a predetermined voltage threshold Vcomp-th2 used by the second burst mode detection circuit for burst mode determination.

For the drive signal DRV, the horizontal axis of the coordinate system represents time t, and the vertical axis represents the level of the drive signal DRV.

For the control signal D11, the horizontal axis of the coordinate system represents time t, and the vertical axis represents the level of the control signal D11.

For the control signal D22, the horizontal axis of the coordinate system represents time t, and the vertical axis represents the level of the control signal D22.

For the control signals D12/D21, the horizontal axis of the coordinate system represents time t, and the vertical axis represents the level of the control signals D12/D21. Since the second NMOSFET M12 in the first switching circuit SW1 and the first NMOSFET M21 in the second switching circuit SW2 are constantly on, the control signals D12/D21 are always high-level signals.

As illustrated in FIG. 6 and FIG. 7 together, first, referring to the timing diagrams for control signal D12 and control signal D21 in FIG. 7, during operation of the dual-output flyback converter illustrated in FIG. 6, the first burst mode detection circuit transmits a high-level control signal D12 to the second NMOSFET M12 in the first switching circuit SW1 to keep the second NMOSFET M12 constantly on; and the second burst mode detection circuit transmits a high-level control signal D21 to the first NMOSFET M21 in the second switching circuit SW2 to keep the first NMOSFET M21 constantly on.

At time t0, the output voltage Vo2 is less than or equal to the reference voltage Vref2. The second burst mode detection circuit determines that the second operation result Vcomp2 output by the second operational amplifier is less than the predetermined voltage threshold Vcomp-th2, determining that the second load branch has entered the light-load state, i.e., the second load branch needs to enter the burst mode. Consequently, the second burst mode detection circuit transmits a low-level control signal D22 to the second NMOSFET M22 of the second switching circuit SW2, controlling the second switching circuit SW2 to turn off. The secondary winding Ns of the first transformer T1 stops transferring energy to the second load branch. The secondary winding Ns of the first transformer T1 supplies all energy thereof to the first load branch.

Since the second output capacitor C2 on the second load branch has stored a specific amount of energy, the second output capacitor C2 may continue to supply power to the second load R2. The output voltage Vo2 supplied by the second output capacitor C2 may gradually decrease over time, the difference between the output voltage Vo2 and the reference voltage Vref2 may continuously increase, and correspondingly, the second operation result Vcomp2 may continuously increase.

At time t1, the second operation result Vcomp2 is equal to the predetermined voltage threshold Vcomp-th2. The second burst mode detection circuit determines that the second load branch has exited the light-load state, i.e., exited the burst mode. Since the first load branch and the second load branch are in the complementary conduction state, the second switching circuit SW2 may only switch to the on state in a case where the dual-output flyback converter completes the on-time of the current cycle. The dual-output flyback converter completing the on-time of the current cycle may also be understood as the first power switching transistor S1 completing the on-time of the current cycle.

Referring to the timing of the drive signal DRV and the control signals D11, D22 in FIG. 7, the first power switching transistor S1 on the primary side and the first switching circuit SW1 need to complete their respective on-times during the period from t1 to t2. Therefore, the second load branch needs to remain off during the period from t1 to t2, i.e., the control signal D22 is at a low level during the period from t1 to t2. During the period from t1 to t2, the second output capacitor C2 is not replenished with energy, and thus the output voltage Vo2 may further decrease.

At time t2, the dual-output flyback converter completes the on-time of the current cycle. The second burst mode detection circuit transmits a high-level control signal D22 to the second NMOSFET M22 on the second load branch. The second NMOSFET M22 is turned on, such that electrical conduction is achieved between the second load branch and the secondary winding Ns of the first transformer T1. The output capacitor C2 on the second load branch is charged, the output voltage Vo2 supplied by the second output capacitor C2 gradually increases, the difference between the output voltage Vo2 and the reference voltage Vref2 gradually decreases, and correspondingly, the second operation result Vcomp2 gradually decreases.

Throughout the entire operating process of the dual-output flyback converter, the second burst mode detection circuit monitors the load condition of the second load branch in real time.

At time t3, the second burst mode detection circuit again detects that the second operation result Vcomp2 is less than the predetermined voltage threshold Vcomp-th2. The second load branch re-enters the light-load state and enters the burst mode. The second burst mode detection circuit transmits a low-level control signal D22 to the second NMOSFET M22 on the second load branch, such that the second NMOSFET M22 is turned off and thus the second switching circuit SW2 is turned off. Upon time t3, the output voltage Vo2 may continuously decrease until the second load branch exits the light-load state, exits the burst mode, and is turned on again.

In this way, the process is repeated continuously, thereby achieving control of the output voltage Vo2 on the second load branch.

During the above process, the first load branch is a non-light-load branch, and the first burst mode detection circuit transmits the control signals D11 and D12 to the switching circuit SW1 according to a pre-designed switching cycle. Referring to the timing of the first control signals D11 and D12 and the drive signal DRV, it is apparent that the first control signal D11 and the drive signal DRV are in the complementary conduction state during the time period from t1 to t2.

In a case where the total load condition has not reached the system light-load threshold, when it is detected that the first load branch is a light-load branch and the second load branch is a non-light-load branch, the control method for the first load branch is similar to that for the second load branch. For details, reference may be made to the detailed description above, which are not described herein any further for the sake of brevity.

Furthermore, in a case where both the first load branch and the second load branch are in the light-load state, the primary control circuit 22c is capable of determining that the total load condition has reached the system light-load threshold based on the first operation result Vcomp1 transmitted from the first load control circuit and the second operation result Vcomp2 transmitted from the second load control circuit, and then controlling the first power switching transistor S1 to enter the burst mode (i.e., enter an intermittent pulse transmission state).

### Case 3: The Switching Assembly is a Bidirectional Switch

A bidirectional switch is a switch capable of being bidirectionally turned on. In a case where a bidirectional switch is turned on, current may flow in both directions. In the present disclosure, in a case where the bidirectional switch is turned on, current may flow in the direction from the secondary winding to the load branch, and energy may be transferred from the secondary winding of the first transformer to the load; or in a case where the bidirectional switch is turned off, the body diodes within the bidirectional switch are in a reverse series configuration, and current flow may be blocked in the direction from the load branch to the secondary winding.

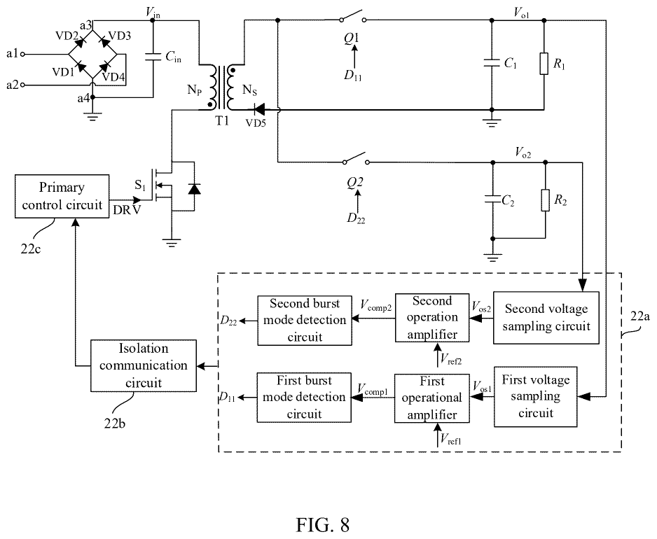

FIG. 8 is a structural diagram of a dual-output flyback converter according to an embodiment of the present disclosure. Referring to FIG. 8, the primary circuit of the dual-output flyback converter is identical in structure to the primary circuit illustrated in FIG. 2. For details, reference may be made to the detailed description of FIG. 2, which are not described herein any further for the sake of brevity. Furthermore, on the secondary circuit, a second terminal of the secondary winding Ns of the first transformer T1 is electrically connected to a cathode of a fifth diode VD5, and an anode of the fifth diode VD5 is connected to the second ends of both of the two load branches and is grounded.

On the secondary circuit, a first load branch includes a first bidirectional switch Q1, a first output capacitor C1, and a first load R1. A first terminal of the first bidirectional switch Q1, serving as a first terminal of a first switching circuit SW1, is electrically connected to a first terminal of the secondary winding Ns of the first transformer T1; a second terminal of the first bidirectional switch Q1, serving as a second terminal of the first switching circuit SW1, is electrically connected to a first terminal of the first output capacitor C1; and a third terminal of the first bidirectional switch Q1, serving as a control signal input terminal of the first switching circuit SW1, is electrically connected to an output terminal of a first burst mode detection circuit on a first load control circuit. A second terminal of the first output capacitor C1 is grounded. A first terminal of the first load R1 is electrically connected to the first terminal of the first output capacitor C1, and a second terminal of the first load R1 is grounded. The first burst mode detection circuit transmits a control signal D11 to the first bidirectional switch Q1.

A second load branch includes a second bidirectional switch Q2, a second output capacitor C2, and a second load R2. A first terminal of the second bidirectional switch Q2, serving as a first terminal of a second switching circuit SW2, is electrically connected to the first terminal of the secondary winding Ns of the first transformer T1; a second terminal of the second bidirectional switch Q2, serving as a second terminal of the second switching circuit SW2, is electrically connected to a first terminal of the second output capacitor C2; and a third terminal of the second bidirectional switch Q2, serving as a control signal input terminal of the second switching circuit SW2, is electrically connected to an output terminal of a second burst mode detection circuit on a second load control circuit. A second terminal of the second output capacitor C2 is grounded. A first terminal of the second load R2 is electrically connected to the first terminal of the second output capacitor C2, and a second terminal of the second load R2 is grounded. The second burst mode detection circuit transmits a control signal D22 to the second bidirectional switch Q2.

The operating process of the dual-output flyback converter illustrated in FIG. 8 is as follows.

The first load control circuit determines the load condition of the first load branch. In a case where it is determined that the first load branch has entered a light-load state, the first load branch controls the first bidirectional switch Q1 to turn on in the direction from the first load branch to the secondary winding; or in a case where the first load branch exits the light-load state, the first load branch controls the first bidirectional switch Q1 to turn off.

The second load control circuit determines the load condition of the second load branch. In a case where it is determined that the second load branch has entered a light-load state, the second load branch controls the second bidirectional switch Q2 to turn on in the direction from the second load branch to the secondary winding; or in a case where the second load branch exits the light-load state, the second load branch controls the second bidirectional switch Q2 to turn off.

The operating process of the dual-output flyback converter illustrated in FIG. 8 is similar to that of the dual-output flyback converter illustrated in FIG. 5. For details, reference may be made to the detailed description of FIG. 5, which are not described herein any further for the sake of brevity.

In summary, the dual-output flyback converters illustrated in FIG. 5, FIG. 7, and FIG. 8 are capable of determining whether each load branch needs to enter the burst mode by separately detecting the load condition of each load branch, and the primary control circuit 22c is capable of controlling whether the first power switching transistor needs to enter the burst mode.

Specifically, the following control may be implemented:

In a case where the first load branch is in a light-load state and the total load condition has not reached the system light-load threshold, the first load branch is individually controlled to enter the burst mode. In this case, all energy is supplied to the second load branch.

In a case where the second load branch is in a light-load state and the total load condition has not reached the system light-load threshold, the second load branch is individually controlled to enter the burst mode. In this case, all energy is supplied to the first load branch.

In a case where both the first load branch and the second load branch are in the light-load state, the first power switching transistor S1 on the primary side is controlled to enter the burst mode based on the total load condition reaching the system light-load threshold.

In the present disclosure, in a case where a light-load branch enters the burst mode, i.e., the light-load branch is electrically disconnected from the secondary winding, the light-load branch does not need to perform switching operations. This reduces the number of switching operations for the light-load branch, thereby reducing the switching loss caused by the light-load branch and improving the energy conversion efficiency of the multi-output flyback converter. Meanwhile, this prevents the phenomenon of excessive energy in a load branch, which occurs when the multi-output flyback converter absorbs more energy than the actual demand of the load due to unreasonable energy distribution, thereby improving the reliable and stable operation of the light-load branch.

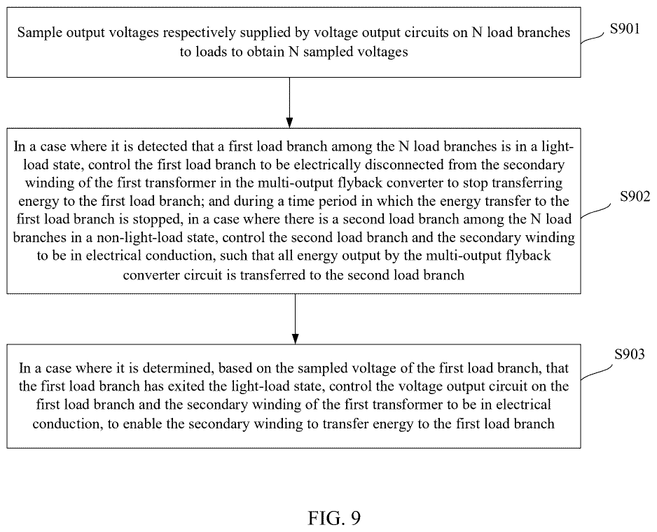

FIG. 9 is a flowchart of a control method for a multi-output flyback converter according to an embodiment of the present disclosure. The method according to this embodiment is applied to the controller in the multi-output flyback converter. For the structure of the multi-output flyback converter and the connection relationship between the controller and the multi-output flyback converter circuit and the N load branches in the multi-output flyback converter, reference may be made to the detailed description of the embodiment illustrated in FIG. 3.

Referring to FIG. 9, the control method for the multi-output flyback converter according to this embodiment is as follows.

In S901, output voltages respectively supplied by voltage output circuits on N load branches to loads are sampled to obtain N sampled voltages.

Referring to FIG. 3, the controller includes N load control circuits, and the N load control circuits are in one-to-one correspondence with the N load branches. Any load control circuit includes a voltage sampling circuit, an operational amplifier, and a burst mode detection circuit.

The output voltage of the connected voltage output circuit is sampled using the voltage sampling circuit on a load control circuit. In this way, sampled voltages corresponding to the N load branches may be obtained respectively.

In S902, in a case where it is detected that a first load branch among the N load branches is in a light-load state, the first load branch is controlled to be electrically disconnected from the secondary winding of the first transformer in the multi-output flyback converter to stop transferring energy to the first load branch; and during a time period in which the energy transfer to the first load branch is stopped, in a case where there is a second load branch among the N load branches in a non-light-load state, the second load branch and the secondary winding are controlled to be in electrical conduction, such that all energy output by the multi-output flyback converter circuit is transferred to the second load branch.

A load branch among the N load branches that is in the light-load state is referred to as a first load branch, and there may be one or a plurality of first load branches. In a case where there are a plurality of first load branches, the output voltages respectively supplied by the voltage output circuits on the multiple first load branches to the loads may be equal or unequal, which is not limited in the present disclosure. Similarly, a branch among the N load branches that is in the non-light-load state is referred to as a second load branch, and there may be one or a plurality of second load branches. In a case where there are a plurality of second load branches, the output voltages respectively supplied by the voltage output circuits on the multiple second load branches may be equal or unequal, which is not limited in the present disclosure.

For any given load control circuit, the load control circuit obtains, by calculation using an operational amplifier, an operation result based on the sampled voltage and a reference voltage corresponding to the load branch, and then compares, using a burst mode detection circuit, the operation result with a predetermined voltage threshold to determine whether the corresponding load branch has entered the light-load state. In some embodiments, in a case where a voltage comparison result is greater than or equal to the predetermined voltage threshold, it is determined that the load branch has exited the light-load state; or in a case where the voltage comparison result is less than the predetermined voltage threshold, it is determined that the load branch is in the light-load state.

This is performed in a case that the total load condition of the N load branches has not reached the system light-load threshold.

In a case where the burst mode detection circuit on any load control circuit determines that a load branch is in the light-load state (i.e., the load branch is a first load branch), the burst mode detection circuit transmits a control signal to the switching circuit in the voltage output circuit on the first load branch to control the switching circuit to turn off. In this way, the first load branch is electrically disconnected from the secondary winding of the first transformer, thereby stopping the secondary winding from transferring energy to the first load branch.

In a case where the burst mode detection circuit on any load control circuit determines that a load branch is a non-light-load branch (i.e., the load branch is a second load branch), the burst mode detection circuit transmits a control signal to the switching circuit in the voltage output circuit on the second load branch to control the switching circuit to turn on. In this way, electrical conduction is achieved between the second load branch and the secondary winding of the first transformer, enabling the secondary winding to transfer all energy to the second load branch.

It should be noted that in the present disclosure, the total load condition of the N load branches represents the sum of the power required by the N load branches.

In this embodiment, the multi-output flyback converter is capable of controlling the energy transfer from the first transformer to the loads based on the actual power demand of the loads, which reduces the energy loss caused by the light-load branches and improves the energy conversion efficiency of the multi-output flyback converter. Meanwhile, the problem of excessive energy in the light-load branches is avoided.

Based on the embodiment illustrated in FIG. 9, upon S902, the method further includes: S903, in a case where it is determined, based on the sampled voltage of the first load branch, that the first load branch has exited the light-load state, controlling the voltage output circuit on the first load branch and the secondary winding of the first transformer to be in electrical conduction, to enable the secondary winding to transfer energy to the first load branch.

The load control circuit corresponding to the first load branch performs energy transfer control for the first load branch. Specifically, the voltage sampling circuit on the load control circuit samples, in real time, the output voltage supplied by the voltage output circuit on the first load branch to the load. By calculation using an operational amplifier, a voltage comparison result is obtained based on the sampled voltage and a reference voltage corresponding to the first load branch. In a case where the burst mode detection circuit determines that the voltage comparison result is greater than or equal to a predetermined voltage threshold corresponding to the first load branch, the burst mode detection circuit determines that the first load branch has exited the light-load state, and controls the first load branch and the secondary winding of the first transformer to be in electrical conduction, to replenish energy to the first load branch via the secondary winding.

It should be noted that for content not disclosed in detail in the method embodiment illustrated in FIG. 9, reference may be made to the detailed descriptions of the embodiments illustrated in FIG. 2 to FIG. 8, which is not described herein any further for the sake of brevity.

According to this embodiment, energy may be transferred to the loads at appropriate times based on the actual power demand of the load branches, which avoids energy overcharging and improves the energy conversion efficiency of the entire system.

An embodiment of the present disclosure further provides a controller. The controller is configured to perform the operations performed by the controller in any of the above embodiments.

An embodiment of the present disclosure further provides a chip. The chip includes the multi-output flyback converter according to any of the above embodiments.

An embodiment of the present disclosure further provides a switched-mode power supply. The switched-mode power supply includes the multi-output flyback converter according to any of the above embodiments.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A multi-output flyback converter, comprising: a multi-output flyback converter circuit, N load branches, and a controller, N being a positive integer greater than 1; wherein the multi-output flyback converter circuit comprises a voltage input circuit, a first power switching transistor, and a first transformer comprising a primary winding and a secondary winding; and each of the N load branches comprises a voltage output circuit and a load; wherein
the voltage input circuit is electrically connected to a first terminal of the primary winding, a second terminal of the primary winding is grounded via the first power switching transistor, a first terminal of the secondary winding is electrically connected to respective voltage input terminals of the voltage output circuits on the N load branches, and a second terminal of the secondary winding is indirectly grounded; N first input terminals of the controller are electrically connected in a one-to-one correspondence to N voltage output terminals of the N voltage output circuits, N first output terminals of the controller are electrically connected to control signal input terminals of the N voltage output circuits, and a second output terminal of the controller is electrically connected to a control terminal of the first power switching transistor; and
the controller is configured to: sample, in real time, output voltages supplied by the voltage output circuits on the N load branches to the loads, to obtain N sampled voltages; and control a first load branch among the N load branches to be electrically disconnected from the secondary winding to stop transferring energy to the first load branch, in a case where it is determined, based on the N sampled voltages, that the first load branch is in a light-load state; and
during a time period where the energy transfer to the first load branch stops, in a case where a second load branch among the N load branches is in a non-light-load state and a total load condition of the N load branches has not reached a system light-load threshold, the controller is further configured to control the second load branch to be electrically connected to the secondary winding, such that all energy output by the multi-output flyback converter is transferred to the second load branch.

2. The multi-output flyback converter according to claim 1, wherein the controller is further configured to control the voltage output circuit on the first load branch and the secondary winding to be in electrical conduction to enable the secondary winding to transfer energy to the first load branch, in a case where it is determined, based on the output voltage supplied by the voltage output circuit on the first load branch to the load, that the first load branch exits the light-load state.

3. The multi-output flyback converter according to claim 1, wherein in a case where there are a plurality of the second load branches, the plurality of the second load branches are in a complementary conduction state.

4. The multi-output flyback converter according to claim 1, further comprising: N load control circuits, wherein an n^{th} load control circuit corresponds to an n^{th} load branch, n=1, 2, . . . , N; wherein
the n^{th} load control circuit comprises an n^{th} voltage sampling circuit, an n^{th} operational amplifier, and an n^{th} burst mode detection circuit which are electrically connected in sequence, the n^{th} voltage sampling circuit being electrically connected to a voltage output terminal of an n^{th} voltage output circuit on the n^{th} load branch, and a first output terminal of the n^{th} burst mode detection circuit being electrically connected to a control signal input terminal on the n^{th} voltage output circuit; wherein
the n^{th} voltage sampling circuit is configured to sample an output voltage supplied by the n^{th} voltage output circuit to an n^{th} load to obtain an n^{th} sampled voltage, and input the n^{th} sampled voltage to the n^{th} operational amplifier;
the n^{th} operational amplifier is configured to receive a reference voltage corresponding to the n^{th} load branch and the n^{th} sampled voltage, and perform an operation on the reference voltage corresponding to the n^{th} load branch and the n^{th} sampled voltage to output an n^{th} operation result, wherein the n^{th} operation result is used to indicate a load condition of the n^{th} load branch;
the n^{th} burst mode detection circuit is configured to: determine, based on the n^{th} operation result transmitted from the n^{th} operational amplifier, whether the n^{th} load branch is in the light-load state or a non-light-load state;
the n^{th} burst mode detection circuit is further configured to, in a case where it is determined that the n^{th} load branch is in the light-load state, transmit an n^{th} control signal to the control signal input terminal of the n^{th} voltage output circuit, such that the n^{th} voltage output circuit is electrically disconnected from the secondary winding based on the n^{th} control signal; and
the n^{th} burst mode detection circuit is further configured to, in a case where it is determined that the n^{th} load branch is in the non-light-load state, transmit the n^{th} control signal to the control signal input terminal of the n^{th} voltage output circuit, such that electrical conduction is achieved between the n^{th} voltage output circuit and the secondary winding based on the n^{th} control signal.

5. The multi-output flyback converter according to claim 4, wherein the n^{th} burst mode detection circuit is specifically configured to: determine that the n^{th} load branch is in the light-load state in a case where the n^{th} operation result is less than a predetermined voltage threshold corresponding to the n^{th} load branch; and determine that the n^{th} load branch is in the non-light-load state in a case where the n^{th} operation result is greater than or equal to the predetermined voltage threshold.

6. The multi-output flyback converter according to claim 4, wherein the n^{th} voltage output circuit comprises an n^{th} switching circuit and an n^{th} output capacitor, the first output terminal of the n^{th} burst mode detection circuit being electrically connected to a control signal input terminal of the n^{th} switching circuit;
wherein the n^{th} burst mode detection circuit is specifically configured to control the n^{th} switching circuit to turn on or turn off, such that electrical conduction or disconnection between the n^{th} load branch and the secondary winding is achieved.

7. The multi-output flyback converter according to claim 6, wherein the n^{th} switching circuit comprises a first unidirectional switch and a second unidirectional switch that are connected in series; and the n^{th} burst mode detection circuit is specifically configured to transmit a same n^{th} control signal to the first unidirectional switch and the second unidirectional switch such that the n^{th} load branch is electrically disconnected from the secondary winding in a case where the n^{th} load branch is in the light-load state, and transmit the same n^{th} control signal to the first unidirectional switch and the second unidirectional switch such that electrical conduction is achieved between the n^{th} load branch and the secondary winding in a case where the n^{th} load branch exits the light-load state; or
the n^{th} switching circuit is a back-to-back metal-oxide-semiconductor field-effect transistor (MOSFET) module; and the n^{th} burst mode detection circuit is specifically configured to transmit different n^{th} control signals to two MOSFETs of the back-to-back MOSFET module respectively to control one MOSFET of the back-to-back MOSFET module to be constantly on and control the other MOSFET of the back-to-back MOSFET module to turn off in a case where the n^{th} load branch is in the light-load state, such that the n^{th} load branch is electrically disconnected from the secondary winding, and control the other MOSFET of the back-to-back MOSFET module to turn on in a case where the n^{th} load branch exits the light-load state, such that electrical conduction is achieved between the n^{th} load branch and the secondary winding; or
the n^{th} switching circuit is a bidirectional switch; and the n^{th} burst mode detection circuit is specifically configured to transmit the n^{th} control signal to the bidirectional switch based on whether the corresponding n^{th} load branch is in the light-load state, such that the bidirectional switch is turned on or turned off along a first direction, wherein the first direction is a direction from the secondary winding to the n^{th} load branch.

8. The multi-output flyback converter according to claim 4, wherein the controller further comprises an isolation communication circuit and a primary control circuit, wherein the isolation communication circuit is disposed between the N load control circuits and the primary control circuit, and an output terminal of the primary control circuit is electrically connected to the control terminal of the first power switching transistor; wherein
the operational amplifiers on the N load control circuits are configured to respectively transmit the generated operation results to the primary control circuit via the isolation communication circuit; and
the primary control circuit is configured to control, based on the received N operation results, the first power switching transistor to turn on or turn off.

9. A control method for a multi-output flyback converter, wherein the multi-output flyback converter comprises a multi-output flyback converter circuit, N load branches, and a controller, N being a positive integer greater than 1; wherein the multi-output flyback converter circuit comprises a voltage input circuit, a first power switching transistor, and a first transformer comprising a primary winding and a secondary winding; and each of the N load branches comprises a voltage output circuit and a load; wherein
the voltage input circuit is electrically connected to a first terminal of the primary winding, a second terminal of the primary winding is grounded via the first power switching transistor, a first terminal of the secondary winding is electrically connected to respective voltage input terminals of the voltage output circuits on the N load branches, and a second terminal of the secondary winding is indirectly grounded; N first input terminals of the controller are electrically connected in a one-to-one correspondence to N voltage output terminals of the N voltage output circuits, N first output terminals of the controller are electrically connected to control signal input terminals of the N voltage output circuits, and a second output terminal of the controller is electrically connected to a control terminal of the first power switching transistor; and
wherein the method comprising:
sampling, by the controller, in real time, output voltages supplied by voltage output circuits on N load branches of the multi-output flyback converter to loads, to obtain N sampled voltages, wherein N is a positive integer greater than 1;
controlling, by the controller, a first load branch among the N load branches to be electrically disconnected from a secondary winding of a first transformer in the multi-output flyback converter to stop transferring energy to the first load branch, in a case where it is determined, based on the N sampled voltages, that the first load branch is in a light-load state; and
during a time period where the energy transfer to the first load branch is stopped, in a case where a second load branch among the N load branches is in a non-light-load state and a total load condition of the N load branches has not reached a system light-load threshold, controlling, by the controller, the second load branch to be electrically connected to the secondary winding, such that all energy output by a multi-output converter circuit in the multi-output flyback converter is transferred to the second load branch.

10. The method according to claim 9, further comprising:
controlling, by the controller, the voltage output circuit on the first load branch and the secondary winding to be in electrical conduction to enable the secondary winding to transfer energy to the first load branch, in a case where it is determined, based on the output voltage supplied by the voltage output circuit on the first load branch to the load, that the first load branch exits the light-load state.

11. The method according to claim 9, wherein the multi-output flyback converter further comprises: N load control circuits, wherein an n^{th} load control circuit corresponds to an n^{th} load branch, n=1, 2, . . . , N; wherein
the n^{th} load control circuit comprises an n^{th} voltage sampling circuit, an n^{th} operational amplifier, and an n^{th} burst mode detection circuit which are electrically connected in sequence, the n^{th} voltage sampling circuit being electrically connected to a voltage output terminal of an n^{th} voltage output circuit on the n^{th} load branch, and a first output terminal of the n^{th} burst mode detection circuit being electrically connected to a control signal input terminal on the n^{th} voltage output circuit; wherein
the method further comprises:
sampling, by the n^{th} voltage sampling circuit, an output voltage supplied by the n^{th} voltage output circuit to an n^{th} load to obtain an n^{th} sampled voltage, and inputting the n^{th} sampled voltage to the n^{th} operational amplifier;
receiving, by the n^{th} operational amplifier, a reference voltage corresponding to the n^{th} load branch and the n^{th} sampled voltage, and performing an operation on the reference voltage corresponding to the n^{th} load branch and the n^{th} sampled voltage to output an n^{th} operation result, wherein the n^{th} operation result is used to indicate a load condition of the n^{th} load branch;
determining, by the n^{th} burst mode detection circuit, based on the n^{th} operation result transmitted from the n^{th} operational amplifier, whether the n^{th} load branch is in the light-load state or a non-light-load state;
in a case where it is determined that the n^{th} load branch is in the light-load state, transmitting, by the n^{th} burst mode detection circuit, an n^{th} control signal to the control signal input terminal of the n^{th} voltage output circuit, such that the n^{th} voltage output circuit is electrically disconnected from the secondary winding based on the n^{th} control signal; and
in a case where it is determined that the n^{th} load branch is in the non-light-load state, transmitting, by the n^{th} burst mode detection circuit, the n^{th} control signal to the control signal input terminal of the n^{th} voltage output circuit, such that electrical conduction is achieved between the n^{th} voltage output circuit and the secondary winding based on the n^{th} control signal.

12. The method according to claim 11, further comprising:
determining, by the n^{th} burst mode detection circuit, that the n^{th} load branch is in the light-load state in a case where the n^{th} operation result is less than a predetermined voltage threshold corresponding to the n^{th} load branch; and determining that the n^{th} load branch is in the non-light-load state in a case where the n^{th} operation result is greater than or equal to the predetermined voltage threshold.

13. The method according to claim 11, wherein the n^{th} voltage output circuit comprises an n^{th} switching circuit and an n^{th} output capacitor, the first output terminal of the n^{th} burst mode detection circuit being electrically connected to a control signal input terminal of the n^{th} switching circuit;
wherein the method further comprises:
controlling, by the n^{th} burst mode detection circuit, the n^{th} switching circuit to turn on or turn off, such that electrical conduction or disconnection between the n^{th} load branch and the secondary winding is achieved.

14. The method according to claim 13, wherein the n^{th} switching circuit comprises a first unidirectional switch and a second unidirectional switch that are connected in series; and the method further comprises:
transmitting, by the n^{th} burst mode detection circuit, a same n^{th} control signal to the first unidirectional switch and the second unidirectional switch such that the n^{th} load branch is electrically disconnected from the secondary winding in a case where the n^{th} load branch is in the light-load state, and transmitting the same n^{th} control signal to the first unidirectional switch and the second unidirectional switch such that electrical conduction is achieved between the n^{th} load branch and the secondary winding in a case where the n^{th} load branch exits the light-load state; or
the n^{th} switching circuit is a back-to-back metal-oxide-semiconductor field-effect transistor (MOSFET) module; and the method further comprises: transmitting, by the n^{th} burst mode detection circuit, different n^{th} control signals to two MOSFETs of the back-to-back MOSFET module respectively to control one MOSFET of the back-to-back MOSFET module to be constantly on and control the other MOSFET of the back-to-back MOSFET module to turn off in a case where the n^{th} load branch is in the light-load state, such that the n^{th} load branch is electrically disconnected from the secondary winding, and controlling the other MOSFET of the back-to-back MOSFET module to turn on in a case where the n^{th} load branch exits the light-load state, such that electrical conduction is achieved between the n^{th} load branch and the secondary winding; or
the n^{th} switching circuit is a bidirectional switch, and the method further comprises: transmitting, by the n^{th} burst mode detection circuit, the n^{th} control signal to the bidirectional switch based on whether the corresponding n^{th} load branch is in the light-load state, such that the bidirectional switch is turned on or turned off along a first direction, wherein the first direction is a direction from the secondary winding to the n^{th} load branch.

15. The method according to claim 11, wherein the controller further comprises an isolation communication circuit and a primary control circuit, wherein the isolation communication circuit is disposed between the N load control circuits and the primary control circuit, and an output terminal of the primary control circuit is electrically connected to the control terminal of the first power switching transistor;
wherein the method further comprises:
respectively transmitting, by the operational amplifiers on the N load control circuits, the generated operation results to the primary control circuit via the isolation communication circuit; and
controlling, by the primary control circuit, based on the received N operation results, the first power switching transistor to turn on or turn off.

16. A switched-mode power supply, comprising a multi-output flyback converter, wherein the multi-output flyback converter comprises: a multi-output flyback converter circuit, N load branches, and a controller, N being a positive integer greater than 1; wherein the multi-output flyback converter circuit comprises a voltage input circuit, a first power switching transistor, and a first transformer comprising a primary winding and a secondary winding; and each of the N load branches comprises a voltage output circuit and a load; wherein
the voltage input circuit is electrically connected to a first terminal of the primary winding, a second terminal of the primary winding is grounded via the first power switching transistor, a first terminal of the secondary winding is electrically connected to respective voltage input terminals of the voltage output circuits on the N load branches, and a second terminal of the secondary winding is indirectly grounded; N first input terminals of the controller are electrically connected in a one-to-one correspondence to N voltage output terminals of the N voltage output circuits, N first output terminals of the controller are electrically connected to control signal input terminals of the N voltage output circuits, and a second output terminal of the controller is electrically connected to a control terminal of the first power switching transistor; and
the controller is configured to: sample, in real time, output voltages supplied by the voltage output circuits on the N load branches to the loads, to obtain N sampled voltages; and control a first load branch among the N load branches to be electrically disconnected from the secondary winding to stop transferring energy to the first load branch, in a case where it is determined, based on the N sampled voltages, that the first load branch is in a light-load state; and
during a time period where the energy transfer to the first load branch stops, in a case where a second load branch among the N load branches is in a non-light-load state and a total load condition of the N load branches has not reached a system light-load threshold, the controller is further configured to control the second load branch to be electrically connected to the secondary winding, such that all energy output by the multi-output flyback converter is transferred to the second load branch.

17. The switched-mode power supply according to claim 16, wherein the controller is further configured to control the voltage output circuit on the first load branch and the secondary winding to be in electrical conduction to enable the secondary winding to transfer energy to the first load branch, in a case where it is determined, based on the output voltage supplied by the voltage output circuit on the first load branch to the load, that the first load branch exits the light-load state.

18. The switched-mode power supply according to claim 16, further comprising: N load control circuits, wherein an n^{th} load control circuit corresponds to an n^{th} load branch, n=1, 2, . . . , N; wherein
the n^{th} load control circuit comprises an n^{th} voltage sampling circuit, an n^{th} operational amplifier, and an n^{th} burst mode detection circuit which are electrically connected in sequence, the n^{th} voltage sampling circuit being electrically connected to a voltage output terminal of an n^{th} voltage output circuit on the n^{th} load branch, and a first output terminal of the n^{th} burst mode detection circuit being electrically connected to a control signal input terminal on the n^{th} voltage output circuit; wherein
the n^{th} voltage sampling circuit is configured to sample an output voltage supplied by the n^{th} voltage output circuit to an n^{th} load to obtain an n^{th} sampled voltage, and input the n^{th} sampled voltage to the n^{th} operational amplifier;
the n^{th} operational amplifier is configured to receive a reference voltage corresponding to the n^{th} load branch and the n^{th} sampled voltage, and perform an operation on the reference voltage corresponding to the n^{th} load branch and the n^{th} sampled voltage to output an n^{th} operation result, wherein the n^{th} operation result is used to indicate a load condition of the n^{th} load branch;
the n^{th} burst mode detection circuit is configured to: determine, based on the n^{th} operation result transmitted from the n^{th} operational amplifier, whether the n^{th} load branch is in the light-load state or a non-light-load state;
the n^{th} burst mode detection circuit is further configured to, in a case where it is determined that the n^{th} load branch is in the light-load state, transmit an n^{th} control signal to the control signal input terminal of the n^{th} voltage output circuit, such that the n^{th} voltage output circuit is electrically disconnected from the secondary winding based on the n^{th} control signal; and
the n^{th} burst mode detection circuit is further configured to, in a case where it is determined that the n^{th} load branch is in the non-light-load state, transmit the n^{th} control signal to the control signal input terminal of the n^{th} voltage output circuit, such that electrical conduction is achieved between the n^{th} voltage output circuit and the secondary winding based on the n^{th} control signal.

19. The switched-mode power supply according to claim 18, wherein the n^{th} burst mode detection circuit is specifically configured to: determine that the n^{th} load branch is in the light-load state in a case where the n^{th} operation result is less than a predetermined voltage threshold corresponding to the n^{th} load branch; and determine that the n^{th} load branch is in the non-light-load state in a case where the n^{th} operation result is greater than or equal to the predetermined voltage threshold.

20. The switched-mode power supply according to claim 18, wherein the n^{th} voltage output circuit comprises an n^{th} switching circuit and an n^{th} output capacitor, the first output terminal of the n^{th} burst mode detection circuit being electrically connected to a control signal input terminal of the n^{th} switching circuit;
wherein the n^{th} burst mode detection circuit is specifically configured to control the n^{th} switching circuit to turn on or turn off, such that electrical conduction or disconnection between the n^{th} load branch and the secondary winding is achieved.
